(19) United States
(12) Patent Application Publication
(10) Pub. No.: US 2009/0023393 A1
(43) Pub. Date: Jan. 22, 2009

(54) METHOD AND SYSTEM FOR A WIRELESS MOBILE COMMUNICATION DEVICE TO EXECUTE A FUNCTION OR RECEIVE A SERVICE IN ONE OR MORE REMOTE TRANSMIT/RECEIVE DEVICES BASED ON USER PREFERENCE DATA

(76) Inventors: Arya Behzad, Poway, CA (US); Mark Buer, Gilbert, AZ (US); Jeyhan Karaoguz, Irvine, CA (US); Alexander MacInnis, Ann Arbor, MI (US); Thomas Quigley, Franklin, NC (US); John Walley, Ladera Ranch, CA (US)

Correspondence Address: MCANDREWS HELD & MALLOY, LTD, 500 WEST MADISON STREET, SUITE 3400, CHICAGO, IL, 60661, US

(21) Appl. No.: 11/861,220

(22) Filed: Sep. 25, 2007

Related U.S. Application Data
(60) Provisional application No. 60/950,963, filed on Jul. 20, 2007.

(51) Int. Cl. H04B 1/38

(52) U.S. Cl. 455/73

(57) ABSTRACT

A system and method is provided for a wireless mobile communication device (WMCD) to communicate a signal that may include user preference data to execute a function and/or receive a service in one or more identified remote transmitting/receiving (TX/RX) devices. The signal may be encrypted, and may be used to poll the availability and identity of the one or more remote TX/RX devices. The user preference data may be formatted in a standardized universal language with commands understandable by most remote TX/RX devices for rendering functions or services. If the one or more remote TX/RX devices receive competing and/or conflicting user preference data from a plurality of WMCDs, each of the remote TX/RX devices may arbitrate which function or service to perform according to privileges of each of the user preference data of the respective WMCDs or based on an arbitration decision in the one or more remote TX/RX devices.

### CROSS-REFERENCE TO RELATED APPLICATIONS/INCORPORATION BY REFERENCE

This application also makes reference to: This application makes reference to, claims priority to, and claims the benefit of U.S. Provisional Application Ser. No. 60/950,963 filed on Jul. 20, 2007.

This application also makes reference to:
U.S. patent application Ser. No. ______ (Attorney Docket Number 18383US02) filed on even date herewith; and
U.S. patent application Ser. No. (Attorney Docket Number 18393US02) filed on even date herewith.

Each of the above stated applications is hereby incorporated herein by reference in its entirety

### FIELD OF THE INVENTION

Certain embodiments of the invention relate to wireless communication. More specifically, certain embodiments of the invention relate to a method and system for a wireless mobile communication device to execute a function and/or receive a service in one or more remote transmit/receive (TX/RX) devices based on user preference data.

### BACKGROUND OF THE INVENTION

The field of wireless communication has seen dramatic growth over the last few years. Currently, most people use their wireless devices, be it cellular phones, PDA's, laptops, and/or other devices, for various purposes, business and personal, on a constant and daily basis. Society is truly becoming a wireless one. Many wireless solutions have been introduced, and have made tremendous strides into everyday life.

For example, the use of Wireless Personal Area Networks (WPAN) has been gaining popularity in a great number of applications because of the flexibility and convenience in connectivity they provide. WPAN systems generally replace cumbersome cabling and/or wiring used to connect peripheral devices and/or mobile terminals by providing short distance wireless links that allow connectivity within very narrow spatial limits. WPAN may be based on standardized technologies, for example Class 2 Bluetooth© technology. While WPAN may be very beneficial for certain applications, other applications may require larger service areas and/or capabilities.

To satisfy such needs, other technologies have been developed to provide greater wireless service. Wireless Local Area Networks (WLAN) systems may operate within a wider range. In contrast to the WPAN systems, WLAN provide connectivity to devices that are located within a slightly larger geographical area, such as the area covered by a building or a campus. WLAN systems are generally based on specific standards, for example IEEE 802.11 standard specifications to supplement the communication capacity provided by traditional wired Local Area Networks (LANs) installed in the same geographic area as the WLAN system.

In short, wireless networks may exist to support wireless mobile communication devices (WMCDs). However, while WMCDs have continued to grow in complexity and capability, these WMCDs still continue to suffer from some major limitations, especially physical limitations and power.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A method and/or system is provided for a wireless mobile communication device to execute a function and/or receive a service in one or more remote transmit/receive (TX/RX) devices based on user preference data, substantially as shown in and/or described in accordance to at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary WLAN infrastructure network comprising basic service sets (BSSs) integrated using a common distribution system (DS) with a biometric data acquisition system, in accordance with an embodiment of the invention.

FIG. 2 is a block diagram illustrating a wireless mobile communication device (WMCD) communicating information to available remote transmit/receive (TX/RX) devices based on acquired biometric data, in accordance with an embodiment of the invention.

FIG. 3A is a block diagram illustrating an exemplary communication system where a WMCD executes functions and services in one or more identified remote TX/RX devices based on user preference data, in accordance with an embodiment of the invention.

FIG. 3B is a block diagram illustrating an exemplary arbitration decision in the execution of functions and receiving services among one or more identified remote TX/RX devices when competing and/or conflicting user preference data may be received from a plurality of WMCDs, in accordance with an embodiment of the invention.

FIG. 4 is a flow diagram illustrating exemplary steps for a WMCD to communicate a signal to execute functions and/or receive services in one or more remote transmitting/receiving (TX/RX) devices based on user preference data, in accordance with an exemplary embodiment of the invention.

### DETAILED DESCRIPTION OF THE INVENTION

Certain aspects of the invention may be found in a method and system for a wireless mobile communication device (WMCD) to execute a function in one or more remote communication devices based on user preference data. Exemplary aspects of the invention may comprise a user interface that may enable communication of a signal that may comprise user preference data to execute a function and/or receive a service in one or more identified remote transmitting and/or receiving (TX/RX) devices. The signal may be encrypted, and may be used to poll the availability of and/or determine identity of the one or more remote TX/RX devices. The user preference data may be formatted in a standardized universal language with commands understandable by most remote TX/RX devices for rendering functions or services. In instances where the one or more remote TX/RX devices receive competing and/or conflicting user preference data from a plurality of WMCDs, each of the remote TX/RX devices may arbitrate which function and/or service to perform according to privileges associated with each of the user preference data of the respective WMCDs and/or based on an arbitration decision in the one or more remote TX/RX devices.

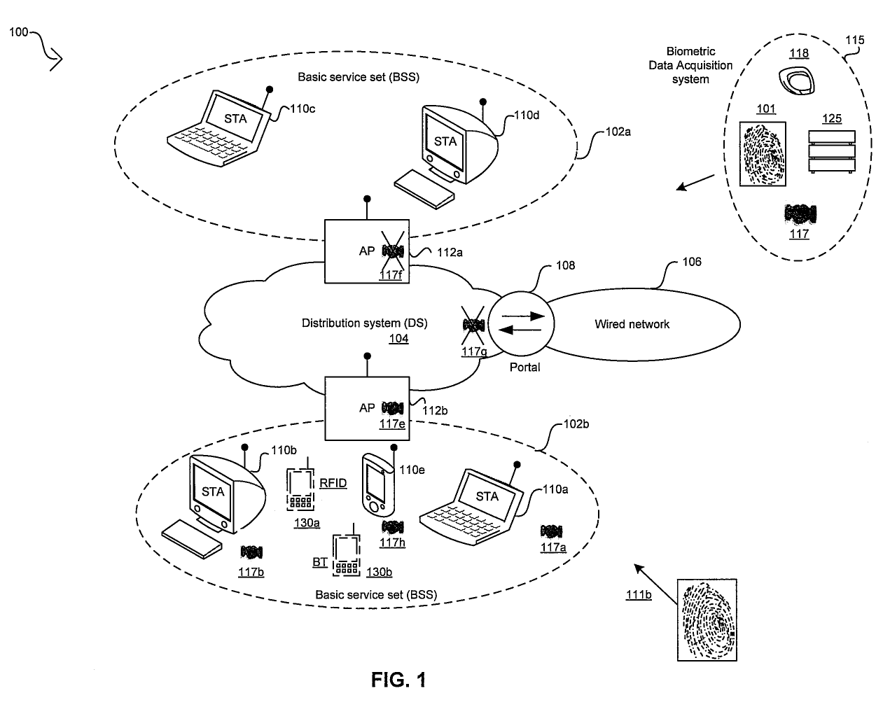

FIG. 1 is a block diagram of an exemplary WLAN infrastructure network comprising basic service sets (BSSs) integrated using a common distribution system (DS) with an optional biometric data acquisition system, in accordance with an embodiment of the invention. Referring to FIG. 1A, there is shown an exemplary secure WLAN infrastructure network 100 comprising a first BSS 102a, a second BSS 102b, a DS 104, a wired network 106, a portal 108, a first access point (AP) 112a, a second AP 112b, remote TX/RX devices such as a plurality of WLAN stations 110a to 110d, a wireless mobile communication device (WMCD) 110e and an optional biometric data acquisition system 115.

The first and second BSSs 102a and 102b may represent a fundamental building block of the IEEE 802.11 (WLAN) architecture and may be defined as a group of stations that are under the direct control of a single coordination function. The geographical area covered by a BSS is known as the basic service area (BSA). The distribution system DS 104 may be utilized to integrate the BSSs 102a and 102b and may comprise suitable hardware, logic, circuitry, and/or code that may be adapted to operate with edge devices such as switching routers, together with an access network which connects subscribers to their immediate service provider as a backbone network. The BSSs 102a and 102b may be responsible for Medium Access Control (MAC) level transport in the WLAN infrastructure network 100. The DS 104, as specified by the IEEE 802.11 standard, may be implementation independent. For example, the DS 104 may be implemented utilizing IEEE 802.3 Ethernet Local Area Network (LAN), IEEE 802.4 token bus LAN, IEEE 802.5 token ring LAN, Fiber Distributed Data Interface (FDDI) Metropolitan Area Network (MAN), or another IEEE 802.11 wireless medium. The DS 104 may be implemented utilizing the same physical medium as either the first BSS 102a or the second BSS 102b. However, the DS 104 may be logically different from the BSSs 102a or 102b and may be utilized only to transfer packets between the BSSs 102a or 102b and/or to transfer packets between the BSSs 102a or 102b and the wired network 106.

The wired network 106 may comprise suitable hardware, logic, circuitry, and/or code that may be adapted to provide wired networking operations. The wired network 106 may be accessed from the WLAN infrastructure network 100 via the portal 108. The portal 108 may comprise suitable hardware, logic, circuitry, and/or code and may be adapted to integrate the WLAN infrastructure network 100 with non-IEEE 802.11 networks. Moreover, the portal 108 may also be adapted to perform the functional operations of a bridge, such as range extension and/or translation between different frame formats, in order to integrate the WLAN infrastructure network 100 with IEEE 802.11-based networks.

The APs 112a, 112b and portal 108 may function as network gateways connecting or directing network traffic from one network to other networks connected to the DS 104. The APs 112a and 112b may comprise suitable hardware, logic, circuitry, and/or code that may be adapted to support range extension of the WLAN infrastructure network 100 by providing the integration points necessary for network connectivity or network traffic between the BSSs 102a or 102b. The WLAN stations 110a to 110d correspond to WLAN-enabled terminals that comprise suitable hardware, logic, circuitry, and/or code that may be adapted to provide connectivity to the WLAN infrastructure network 100 via the APs 112a or 112b.

The WLAN station 110a and 110c may comprise laptop computers and may correspond to a mobile station or terminal within the BSS and the WLAN station 110b and 110d shown are desktop computers and may correspond to a fixed or stationary terminal within the BSS 102a or 102b. In addition to WLAN enabled devices such as the WLAN station 110a and 110b, there may be other remote TX/RX devices, such as for example an RFID enabled device 130a and a Bluetooth enabled device 130b, communicating to the wireless mobile communication device WMCD 110e.

The WMCD 110e may provide a plurality of functions including mobile communication, and PDA like services. The WMCD 110e may be configured as a mobile modem which may enable broadcasting of a user's preferences at any location continuously or when prompted or requested to do so. In an exemplary embodiment of the invention, the WMCD 110e may be equipped with a data acquisition system capable of acquiring a plurality of data types such as time, date and location data input via a GPS receiver, multimedia data input and optionally biometric data input. The WMCD 110e may store remotely at or retrieve acquired data remotely from an external host or storage through the network BSS 102b, or the TX/RX devices that may be within range such as the WLAN station 110a and 110b.

The optional biometric data acquisition system 115 may comprise a biometric sensor 118, acquired biometric data 101 (from a user), a pattern recognition database 125 and an authentication and validation procedure 117. Biometric data 101, such as finger print or retina data may be unique to a person. Such biometric data 101 may be classified into two main types: physiological and behavioral biometric data. The physiological biometric data may be related to the physical aspect of the body such as facial features, finger prints, hand shape, iris blood vessel pattern (iris scan) and DNA sequences. The behavioral biometric data may be related to the expression of personality such as Electroencephalogram (EEG) that senses and measures brain wave activities, signature, hand writing and voice. Therefore the biometric data may be representative of the actual person or user. An example of the biometric sensor 118 may be a finger print scanner, an iris scanner, hand scanner, EEG brain wave electrodes, Galvanic skin response electrodes, or a voice coder.

In an embodiment of the invention, the optional biometric data authentication and validation procedure 117 may be used as a security measure to prevent unauthorized entry or access to a restricted area and/or data other than by the actual designated person. The authentication and validation procedure 117 may comprise the steps of acquiring the biometric data 101 using a biometric sensor 118, extracting biometric features from acquired biometric data 101, generating a template (digitized pattern) from the biometric data 101, sending the template to enroll in a pattern recognition database 125, storing the template (stored template) as corresponding user's captured data into the pattern recognition database 125 for future retrieval, matching or comparing a new acquired biometric data 101 (generated template) with the corresponding data as stored template using a pattern recognition database, such as using a known algorithm. The WMCD 110e may communicate a signal carrying user preference data to remote devices such as the WLAN station 110a and 110c to perform pre-programmed on line banking and/or bill payments.

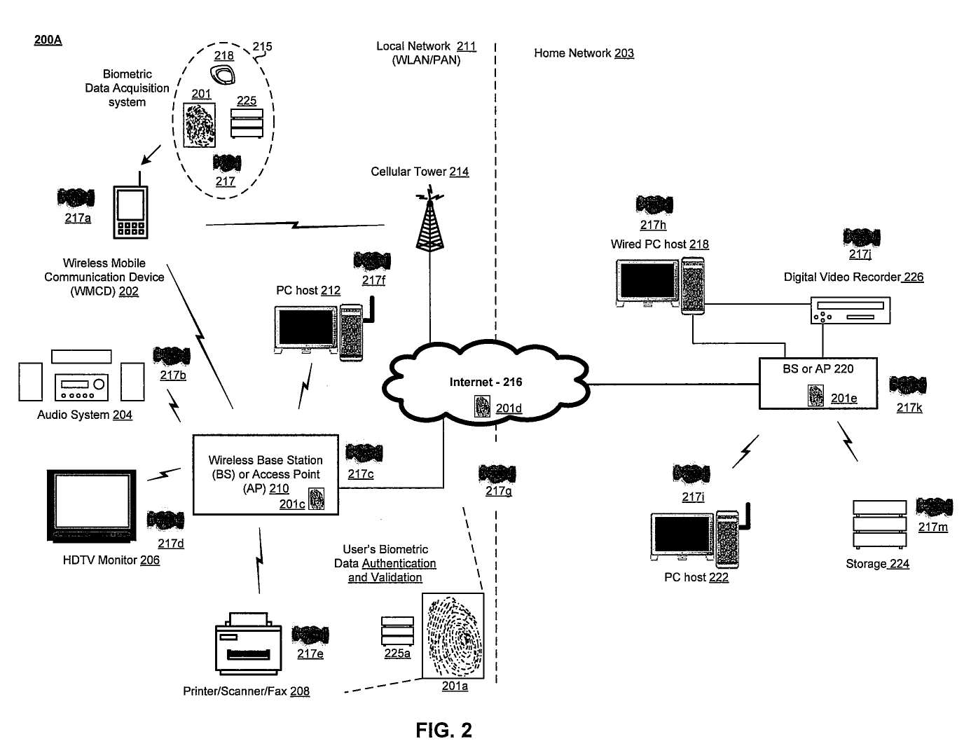

FIG. 2 is a block diagram illustrating a wireless mobile communication device communicating user preference data to available remote TX/RX devices based on acquired biometric data, in accordance with an embodiment of the invention. Referring to FIG. 2, there is shown a WMCD 202 configured an ad hoc network 200A comprising a biometric acquisition system 215 similar to the one described in FIG. 1, a biometric data enabled local network 211 and a biometric data enabled home network 203. The biometric data enabled local network 211 may communicate with the biometric data enabled home network 203 via the biometric data enabled Internet 216. The biometric data enabled local network 211 may comprise a plurality of remote TX/RX devices such as a wireless mobile communication device (WMCD) 202, an audio system 204, an HDTV monitor 206, a printer/scanner/fax 208, a wireless base station or access point 210 and a PC host 212.

Each of the remote TX/RX devices within the biometric data enabled local network 211 or the biometric data enabled home network 203 may comprise a biometric data acquisition system 215 where the communication of information among the remote TX/RX devices within the local network 211 or with the home network 203 may require the steps of user's biometric data authentication and validation 217a to 217m discussed in FIG. 1. Likewise network traffic authentication and validation 217c, 217k and 217d may require matching the respective biometric data 201c, 201d and 201e with respective pattern recognition database at AP 210, 220c and/or the Internet 216.

The biometric data enabled home network 203 may comprise a plurality of remote TX/RX devices or devices such as a wired host PC 218, a PC host 222, a storage 224, a wireless base station or access point 220 and a digital video recorder (DVR) 226. The remote TX/RX devices coupled to the biometric data enabled local network 211 and the biometric data enabled home network 203 may be communicatively coupled to their respective base station or access point 210/220 via a wired or wireless connection utilizing one of a plurality of protocols, such as Bluetooth, wireless LAN 802.11, for example. The number of devices is not limited to the number shown in FIG. 2. Accordingly, any number of networked multimedia input/output remote TX/RX devices may be utilized.

The WMCD 202 may comprise a device capable of communicating wirelessly utilizing a plurality of methods and/or protocols and a plurality of networks. In this example, the network communication may be achieved via the cellular tower 214, or the wireless base station AP 210. The WMCD 202 may function as a cellular phone, personal data assistant, and/or a handheld computing device, for example. In addition, the WMCD 202 may function as a router, in that it may configure itself to use and connect to local and remote TX/RX devices to perform multimedia and communication tasks by auto discovery of local devices and capabilities via standardized network protocols. The user's biometric data 201 may be transmitted as part of the data in the standardized network protocols.

In operation, exemplary remote TX/RX devices such as the audio system 204, HDTV monitor 206, printer/scanner/fax 208, wireless base station or access point 210 and PC host 212 to the mobile device WMCD 202 may announce their capabilities and availability in instances when the WMCD 202 comes in range of them and discovers the wired or wireless network that links them. In another embodiment of the invention, the WMCD 202 may poll for available networks and TX/RX devices. In this manner, the WMCD 202 may maintain a list of local TX/RX devices or devices that it may communicate with along with their capabilities.

The WMCD 202 may keep a list of TX/RX devices available on its biometric data enabled home network 203 and may update that list and the bandwidth capabilities of its connection to the home network 203 via locally available networks 211 at all times. In instances when the user of the mobile device WMCD 202 may wish to accomplish a certain multimedia or communications task, the WMCD 202 may configure the local and remote TX/RX devices in order to accomplish the multimedia or communications task. The WMCD 202 configuration of local and remote TX/RX devices may be saved under the user's preferences comprising authenticated and validated biometric data 201, in accordance to the invention.

In one embodiment of the invention, the biometric data enabled home network 203 TX/RX devices may comprise a powerful PC, such as the wired PC host 218, with large amounts of storage and computing TX/RX devices, including transcoding capabilities and local digital video storage. In addition, the WMCD 202 may be connected to a wireless network that may comprise an HDTV monitor 206 that may be available for use and have high bandwidth connectivity via the Internet to the home network 203. In another embodiment of the invention, the connectivity in the local network 211 may be a personal area network (PAN) or a wireless personal area network (WPAN) via Bluetooth or ultra wide band (UWB). The WMCD 202, however, has internet capability and could fetch multimedia content over the internet and send it to the HDTV monitor 206 via the available local network 211 wirelessly or via cable.

Through the steps of user's biometric data authentication and validation 217a to 217m, the WMCD 202 may create an ad hoc network 200A that may be a virtual network comprising TX/RX devices from the home network 203 to the local network 211. A route may be established where a device based on user's biometric data by configuring both local and remote TX/RX devices to accomplish rendering of multimedia content on dissimilar format devices.

For example, the WMCD 202 may communicate with the TX/RX devices in the biometric data enabled home network 203 to facilitate and coordinate tasks and services. Data may be streamed from a home video storage device, such as the DVR 226, for example, through the wired PC host 218 for transcoding to a different display format. The data may be communicated over the Internet 216 to the local network 211 and to the local HDTV monitor 206 for display. The WMCD 202 may also configure the ad hoc network 200A and the audio system 204 to play audio that corresponds to the video playing on the HDTV monitor 206. In this manner, one or more of the available network routes and TX/RX devices may be discovered for data processing and consumption.

The ad hoc network 200A and connecting of TX/RX devices described above may be achieved by the WMCD 202 creating and updating its list of local and remote TX/RX devices via its biometric data linked user preferences whenever network locality changes. The discovery of local TX/RX devices may be achieved by listening and logging announcement messages that detail TX/RX devices and their capabilities or by querying new local networks for available TX/RX devices. One or both of these functions may be accomplished with standardized protocols. In an exemplary embodiment of the invention, WLAN devices may use, for example, beacons or other types of messages to broadcast their capabilities or available TX/RX devices.

In an exemplary aspect of the invention, the WMCD 202 may be within range of a WLAN, such as the local network 211. The WMCD 202 user may wish to stream video on remote TX/RX devices such as the HDTV monitor 206 and audio for the video on the audio system 204, both from a data source, such as the storage 224, or the DVR 226, on the home network 203, for example. The WMCD 202 may determine whether the WLAN, the local network 211, may be in its list of accessible networks stored in the user's preferences.

In another aspect of the invention, when the WMCD 202 may not have the local network 211 in its stored database of networks and TX/RX devices, the WMCD 202 may receive information broadcasted by network 211, such as the network system IP address, which may comprise information about the wireless protocol, speed and access rights, for example. Such access rights to the biometric data enabled local network 211 may be granted after the WMCD 202 user's biometric data may be enrolled and stored into the network's database as among the approval list.

Various embodiments of methods and systems for discovering remote TX/RX devices within local and remote networks are disclosed in the U.S. patent application (Attorney Docket Number 18393US02) titled “Method and system for configuring local and remote TX/RX devices to accomplish rendering of multimedia content on dissimilar format devices based on user biometric data” filed on even date herewith; and which application is incorporated herein by reference in its entirety.

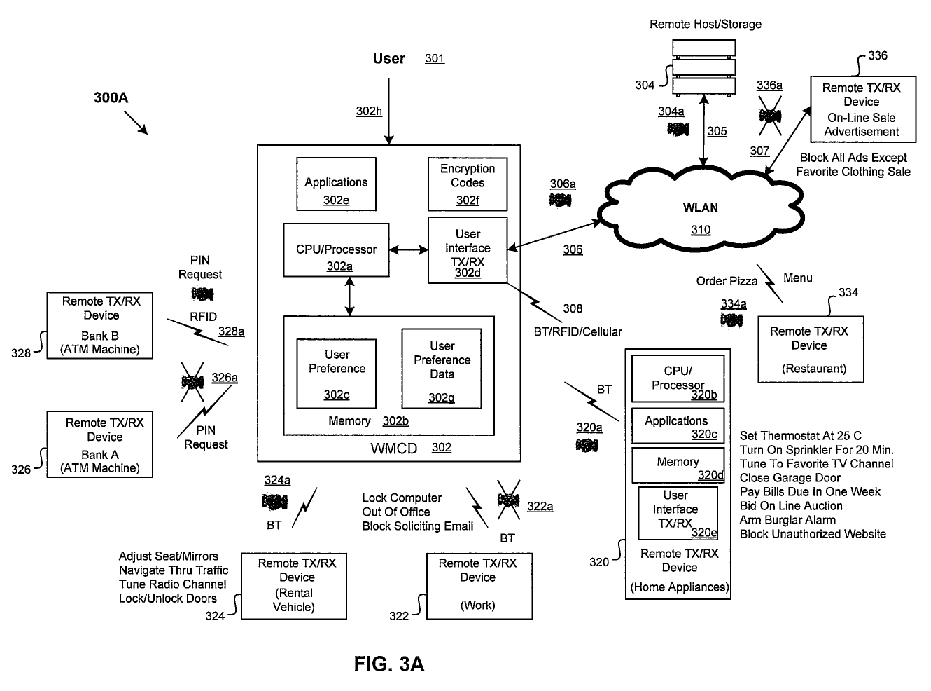

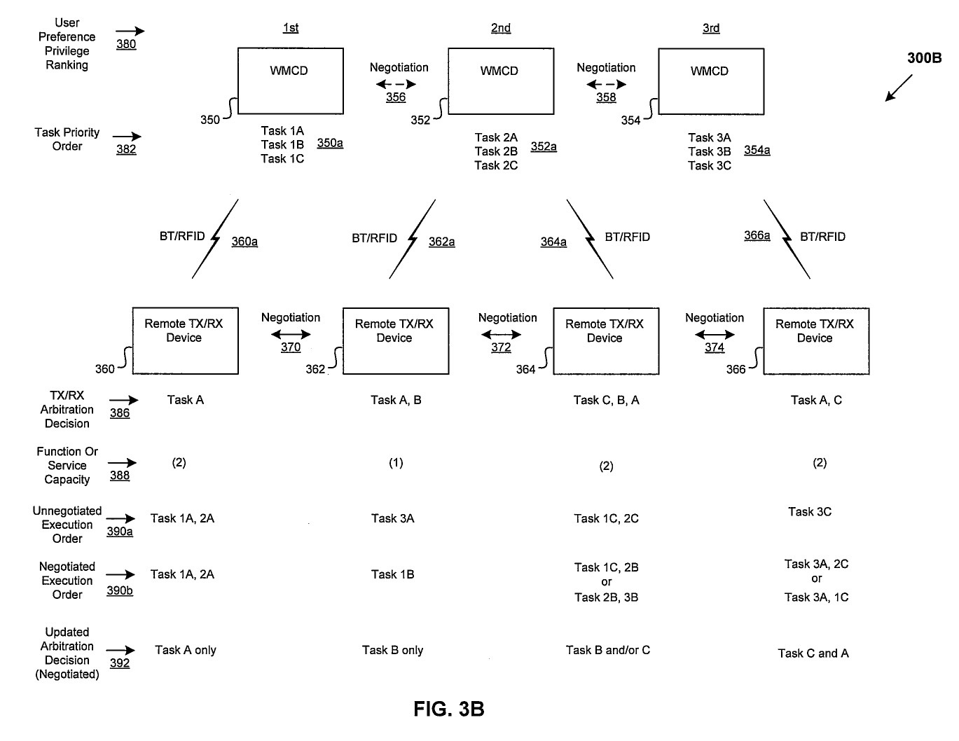

FIG. 3A is a block diagram illustrating an exemplary communication system where a WMCD executes functions and services in one or more identified remote TX/RX devices based on user preference data, in accordance with an embodiment of the invention. Referring to FIG. 3A, there is shown a user 301, providing an input 302h to a WMCD 302, a Wide Area Local Network (WLAN) 310, a remote host or storage 304 and a plurality of remote TX/RX devices 320 to 336 implemented at different locations within the communication range of the WMCD 302. The user 301 may power up the WMCD 302, which may verify the user's identity, in order to gain authorization to access the WMCD 302 through an input 302h. In an embodiment of the invention, the input 302h may be a user preference that matches a data base of the user preference 302c stored in the memory 302b In another embodiment of the invention, the input 302h may be user's biometric data such as user's 301 finger print.

In exemplary embodiment of the invention, the WMCD 302 may comprise a smart phone, a PDA, a handheld computer or any suitable wireless mobile communication device (WMCD) with sufficient CPU processing power, memory and application software to carry out the invention described. The WMCD 302 may comprise at least a CPU/processor 302a, a memory 302b storing the user preference 302c, a user interface 302d with transmit/receive functions, a plurality of applications 302e and optional encryption codes 302f.

The WMCD 302 may communicate I/O data through the user interface 302d in association with the CPU or processor 302a. The CPU or processor 302a may execute suitable codes from the plurality of applications 302e and read or write data to the memory 302b. In an exemplary embodiment of the invention, the plurality of applications 302e may comprise an operating system, one or more supporting application programs to read, write and/or translate incoming input data 302h. The supporting application programs may bind outgoing output data into suitable language or protocol format for network transmission. One such data binding function may be to format the user preference data 320g into a universal language format that may be understandable by most remote communication or host with TX/RX functions.

Some examples of the universal language format may comprise Extensible Markup Language (XML) that enable users to define their own tags and facilitate the sharing of data across different information systems, particularly via the internet. Other languages or protocol may comprise using the Bluetooth or RFID compatible protocol standards. In another embodiment of the invention, the applications 302e may comprise protocol translation capability to translate protocols among several common standards to ensure compatibility in communication.

The optional encryption codes 302f may comprise codes or algorithms to encrypt outgoing data or decrypt incoming data meeting the Data Encryption Standard (DES), for example. Another encryption standard that may be used may be the Advanced Encryption Standard (AES). Encrypting user preference data 302g may improve security and privacy of user information to only authorized recipients. User preference data 302g may be encrypted, for example, in instances where the WMCD 302 exchange account number, PIN number, passwords, credit card number when performing transaction functions at a bank Automatic Teller Machine (ATM) or at a store completing a purchase check out.

In an exemplary embodiment of the invention, the WMCD 302 may broadcast wireless signals 320a to 332a by Bluetooth, RFID or suitable wireless protocol to surrounding resources as the WMCD 302 may be carried by the user 301 from location to location. The wireless signals 320a to 332a may carry user preference data 302g that may be downloaded remotely from a remote host or storage 304 such as a server, or may be locally retrieved within the WMCD 302 memory 302b.

The user preference 302c may comprise linking paths to a vast data base of user preference data 302g. The user preference 302c may be generated in the form of a text keyword, a graphical user interface (GUI) in the form of an icon or image, a spoken phrase of a keyword, a voice command or a biometric data. By invoking the user preference 302c, a query command may be sent to retrieve the corresponding user preference data 302g from the memory 302b.

The user preference data 302g may be captured data such as a personal journal with records and profiles that may be indexed and categorized to be accessed in order to assist the user 301 to make choices, execute tasks, functions and request services expediently. Some examples of the user preference data 302g may comprise a user's identity, bank account numbers, credit card numbers, passwords, history of purchases, spending habits, calendar, planned purchases, service schedule, task list, favorite settings of multimedia devices, home appliances settings control, functional configuration of office equipment, vehicle seat or mirror settings, user's statistics, and/or biometric event data.

In an embodiment of the invention, the user preference data 302g may optionally be pre-tagged with user's biometric data at the time of data acquisition or data capturing. The pre-tagged user preference data 302g may be stored locally or remotely for post processing and analysis. The biometrically pre-tagged user preference data 302g may be used for generating a personal journal and/or user preference 302c based on indexing and mapping of context data tags abstracted from the user preference data 302g. The generated user preference 302c may be used to retrieve user preference data 302g that may be used to configure surrounding remote TX/RX devices 320 to 336 to execute functions, to request services or query information.

Various embodiments of data acquisition system using optional biometric data, and methods of retrieving captured data based on user preference data are disclosed in the U.S. patent application (Attorney Docket Number 18383US02) titled “A Method and system for creating a personalized journal based on collecting links to information and annotating those links for later retrieval” filed on even date herewith; and which application is incorporated herein by reference in its entirety.

A remote TX/RX device such as the remote TX/RX devices planted in TX/RX devices 320 to 336 may be integrated into an electronic device, a merchandise commodity, an equipment, a tool, a home appliance or a vehicle to establish communication with the WMCD 302 through an ad hoc network 300A or a WLAN 310. The remote TX/RX device may function in association with suitable circuits and codes. For example, a home appliance TX/RX device 320 may comprise a TX/RX user interface 320e that may function in association with a CPU or processor 320b, one or more applications 320c, and a memory 320d. Equipment or devices equipped with the TX/RX user interface 320e and associated circuitry and codes may operate under similar principles as the WMCD 302.

Exemplary illustrations of the WMCD 302 communicating a signal such as signals 306, 308, 320a to 336a may execute functions or receive services in one or more identified remote TX/RX devices 320 to 336 may be illustrated. In an embodiment of the invention, the user 301 may carry the WMCD 302 to a home environment where the WMCD 302 may broadcast user preference data 302g via Bluetooth protocol to a plurality of home appliances equipped with remote TX/RX devices 320. For example, on a warm summer day, the home air conditioning unit may be set at a higher temperature when the user may be absent to conserve electricity cost. The networked or network enabled thermostat may be automatically set to a desired temperature, such as 25 degree Celsius, for example, when the user returns home and a Bluetooth signal 320a is sent from the WMCD 302.

Similarly, a networked or network enabled sprinkler system may be turned on for a desired period of time, such as 20 minutes, for example, a networked or network enabled TV may be tuned to user's favorite channel, a networked or network enabled garage door may be closed automatically, the user's networked or network enabled computer may be logged on automatically where the user may browse account balance, review bills and pay all bills due within one week through user preference signal 302g from user 301 bank account. The user preference data 302g may enable automatic dialing to a nearby restaurant, the browsing of a menu and price and placement of a pizza order for delivery. While the user 301 may be watching a favorite channel and eating pizza, the user preference data 302g may monitor an on-line auction on a user's favorite item and execute bidding up to a limit set by the user preference data 302g stored two days ago.

The user 301 may go to work where the WMCD 302 may broadcast a user preference data 302g to arm the networked or network enabled home alarm system and set the networked or network enabled computer preference to block off unauthorized access to a home computer. In instances where the user 301 may drive a rental vehicle equipped with a remote Bluetooth enabled TX/RX device 324 that may recognize the user's WMCD 302, the Bluetooth enabled TX/RX device 324 may receive user preference data 302g via the Bluetooth signal 324a. The WMCD 302 may utilize the Bluetooth signal 324a to automatically configure and/or operate various functions in the rental vehicle. For example, the WMCD 302 may be enabled to utilize the Bluetooth signal 324a to unlock the door, adjust the driver's seat and mirrors positions, and check the car's battery, fuel, brake and/or coolant fluid level. Based on the user preference data 302g, a radio in the rental vehicle may tune to a local radio traffic news channel and may enable navigation of the rental vehicle via GPS utilizing specific routes. When the user 301 arrives work, the WMCD 302 may broadcast corresponding user preference data 302g to a Bluetooth enabled computer. Based on the user preference data 302g, the computer may be enabled to block soliciting emails and lock the work computer after leaving through Bluetooth signal 322a.

The user may go to withdraw cash from an ATM. The user's WMCD 302 may send a signal to poll the ATM machines on the street. The user may first walk pass bank A ATM 326 with a TX/RX device, where bank A's ATM 326 may try to query the user's personal password or PIN. The user preference data 302g may be encrypted for security. In this regard, access to the user preference data 302g may be denied for bank A's ATM 326, but may granted for bank B's ATM 328. The user preference data 302g may specify the amount of cash withdrawn and the user 301 may collect the cash after touching a finger print or retina scanner of bank B's ATM 328 to authenticate the user's identify through a biometric protocol 328a.

The user preference 302c may have a filtering information function such as the selective permission of desired information or services to communicate to the WMCD 302. The user preference 302c may also enable filtering of information that may be broadcasted to or received from one or more designated remote TX/RX devices. The WMCD 302 may be enabled by the user preference 302c to permit entry of certain information through filtering or blocking of unwanted information or an unwanted service solicitation. For example, the user preference 302c may enable a home computer to monitor on line sales advertisement from one or more remote TX/RX servers. The user preference 302c may enable filtering and/or blocking of certain content. For example, the user preference 302c may enable filtering and/or blocking of certain company products on a website except certain favorite brands or classes of products that may be indicated via the user preference 302c.

In an exemplary embodiment of the invention, the user preference 302c may indicate that the user 301 may be interested in receiving information about a clothing sale. The user preference 302c may be set to link to a data base of user preference data 302g such that the user's preferred clothing size, brands, color of clothing, type of fabric and/or price range may be specified. A task reminder in one of the applications 302e in the WMCD 302 may be enabled to determine when there is a clothing sale, which has items that matches criteria indicated by the user preference 302c is occurring. In instances where the criteria indicated by the user preference 302c may be met, the corresponding applications may be enabled to alert the user 301. The alert may comprise a visual alert such as a text message or email, and/or a audio alert such as a tone, or audio message. GPS information may be utilized guide the user 301 to a location of the store that has the items the met the criteria in the user preference 302c.

FIG. 3B is a block diagram illustrating an exemplary arbitration decision in the execution of functions and receiving services among one or more identified remote TX/RX devices when competing and/or conflicting user preference data may be received from a plurality of WMCDs, in accordance with an embodiment of the invention. Referring to FIG. 3B, there is shown an exemplary embodiment of the invention where in an ad hoc network 300B, a plurality of WMCDs 350, 352 and 354 may each send polling signals to identify a plurality of remote TX/RX devices 360 to 366 by communicating signals 360a to 366a via Bluetooth or RFID protocol. In response, each of the remote TX/RX devices 360 to 366 may send back a reply to report their availability to process a task, a function or provide a service upon request.

The signals 360a to 366a may carry user preference data 350a, 352a and 354a representing the functions or services queried by the respective WMCDs 350, 352 and 354 to be performed or executed in the remote TX/RX devices 360 to 366. For example, the WMCD 350 may broadcast a user preference data 350a which may request the execution of functions or receipt of services pertaining to Tasks 1A, 1B and 1C, to remote TX/RX devices 360 to 366. The WMCD 352 may broadcast a user preference data 352a requesting the execution of functions or receipt of services pertaining to Tasks 2A, 2B and 2C, to remote TX/RX devices 360 to 366. The WMCD 354 may broadcast user preference data 354a requesting the execution of functions or receipt of services pertaining to Tasks 3A, 3B and 3C, to remote TX/RX devices 360 to 366.

In an exemplary embodiment of the invention, the user preference data 350a, 352a and 354a generated by WMCD 350, 352, 354 may each carry rank status information reflected as a user preference privilege ranking 380. For example, parents may have a higher user preference privilege ranking 380 than children. An older sibling may have higher user preference privilege ranking 380 than a younger sibling. The user preference privilege ranking 380 may be established based on corporate ranks, or seniority. In this example, the WMCD 350 may have the highest user preference privilege ranking 380 as being ranked first, the WMCD 352 ranked second and the WMCD 354 ranked third. The user preference data 350a to 354a may carry the corresponding ranks in user preference privilege ranking 380.

The user preference privilege ranking 380 may determine priorities in the execution of functions or receipt of services from the plurality of remote TX/RX devices 360 to 366. For example, if WMCD 350 through WMCD 354 simultaneously broadcast user preference data 350a to 354a to the remote TX/RX device 360. The remote TX/RX device 360 may read the user preference privilege ranking 380 in the user preference data 350a through 354a and respond by executing functions or rendering services to WMCD 350 based on ranking priorities, since the user preference data 350a has a higher user preference privilege ranking 380 than the user preference data 352a or 354a. After the remote TX/RX device 360 completes the execution of tasks 1A, 1B and 1C for the WMCD 350, the remote TX/RX device 360 may execute tasks 2A, 2B and 2C and then 3A, 3B and 3C in ranking order. Likewise, task A may be processed first, B next and C last as designated by a task priority 382 in the user preference data 350a to 354a.

In this exemplary embodiment of the invention, the remote TX/RX device 360 may have a function or service capacity 388 of two, which is a capacity to perform two tasks at the same time. According to the same ranking of user preference privilege ranking 380, the remote TX/RX device 360 may execute tasks 1A and 1B, then 1C and 2A, 2B and 2C in the same ranking and order until the last task 3C may be completed. Normally without designating user preference privilege ranking 380 or task priority 382 in the user preference data 350a to 354a, the remote TX/RX device 360 may execute tasks on a first come first served basis, irrespective of WMCDs within the communication range. Other default criteria may be utilized to indicate an order of executing tasks.

In another exemplary embodiment of the invention, the operation of each of the plurality of remote TX/RX devices 360, 362, 364 and 364 may be controlled based on user preference data 350a to 354a or may be independently pre-programmed to handle incoming task request based on a TX/RX arbitration decision 386. For example, the TX/RX arbitration decision 386 in the remote TX/RX device 360 may prefer to handle only task A. The TX/RX arbitration decision 386 in the remote TX/RX device 362 may prefer to handle task A first and then task B. The TX/RX arbitration decision 386 in the remote TX/RX device 364 may prefer to handle task C first, task B next and task A last. The TX/RX arbitration decision 386 in the remote TX/RX device 366 may prefer to handle task A first then task C.

Additionally, each of the WMCDs 360 to 366 may be programmed and provided with at function or service capacity 388. For example, WMCD 360 may have a function or service capacity 388 of two, which means TX/RX device 360 may execute up to two tasks simultaneously. Likewise TX/RX device 362 through 366 may have a function or service capacity 388 of one, two and two respectively.

When multiple WMCDs such as WMCD 350 through 354 broadcast user preferences data 350a through 354a to request execution of nine tasks simultaneously (i.e. task 1A to task 3C) in remote TX/RX device 362 to 366, there may be a capacity limitation since up to, for example, seven tasks may be executed simultaneously. In addition, there may be another limitation such as task A may be processed by all four remote TX/RX device 362 through 366, but task B may be processed only by remote TX/RX devices 362 and 364, and task C may be processed only by remote TX/RX devices 364 and 366. A third limitation may be due to unequal execution of task order in each of the remote TX/RX device 362 through 366 determined by the TX/RX arbitration decision 386, where not all tasks may be executed in equal priority.

In an exemplary embodiment of the invention, the TX/RX arbitration decision 386 may be set by the WMCD with the highest user preference privilege ranking through the corresponding user preference data. In this exemplary embodiment of the invention, the WMCD 350 may set the TX/RX arbitration decision 386 for one or all of the remote TX/RX devices 360 through 366 through the corresponding user preference data 350a. Arbitration in the remote TX/RX devices 360 through 366 may solve the problem of arbitrating, competing or conflicting signals or user preference data from 350a through 354a by setting priority to the processing of competing task requests. Additional processes may be used to solve task execution distribution or capacity utilization issues.

In another exemplary embodiment of the invention, negotiation 370 through 374 among the remote TX/RX devices 360 through 366 may be employed to enhance TX/RX arbitration decision 386. Negotiation may allow the dynamic shifting of priorities or order of execution of tasks, functions or services within the guideline of TX/RX arbitration decision 386. Negotiation results may or may not be under the command of the user preference data 350a through 354a. Accordingly, in an embodiment of the invention, a negotiation function may be independently pre-programmed, programmed or centrally controlled and/or dynamically adjusted by a remote server such as a remote host or storage 304 to communicate negotiation priorities to the remote TX/RX devices 360 through 366.

In this exemplary embodiment of the invention, an execution order using TX/RX arbitration decision 386 alone (un-negotiated execution 390a) is illustrated. The remote device TX/RX device 360 may process tasks 1A and 2A since WMCD 350 has the highest privilege and the TX/RX arbitration decision 386 may process only task A with a function or service capacity 388 of up to two. The TX/RX device 362 may process task 3A only since the TX/RX arbitration decision 386 prefers task A over task B and has a function or service capacity 388 of one. The TX/RX device 364 may process tasks 1C and 2C since the TX/RX arbitration decision 386 prefers task C over task B or task C and has a function or service capacity 388 of two. The TX/RX device 366 may process task 3C only since the TX/RX arbitration decision 386 prefers task A over task C, with a function or service capacity 388 of two.

Since tasks 1A, 2A and 3A may be processed by TX/RX devices 360 and 362 respectively, and tasks 1C and 2C may both be processed by TX/RX devices 364, task 3C may be the only task TX/RX devices 366 may process. With un-negotiated execution order 390a, it may be shown that only six tasks (IA through 3A, and 2C through 3C) out of a capacity of seven may be performed. It may be shown that B task may not be performed in this arbitration, leaving uneven distribution of tasks and under utilization of capacity.

In another embodiment of the invention, an execution order with negotiation 390b may be illustrated. For example, negotiation 370 through 374 among remote TX/RX devices 360 to 366 may take place within the ad hoc network 300B, where the TX/RX arbitration decision 386 among the remote TX/RX devices 360 through 366 may be adjusted dynamically through negotiation of order of execution within the guideline of TX/RX arbitration decision 386. A more uniform task processing distribution and better utilization of capacity in the remote TX/RX devices 360 to 366 may be achieved.

For example, the remote device TX/RX device 360 may process tasks 1A and 2A. Since WMCD 350 has the highest privilege, and since the TX/RX arbitration decision 386 prefers only task A, and has a function or service capacity 388 of up to two. The TX/RX device 362 may be negotiated to process task 1B only instead of 3A although the TX/RX arbitration decision 386 may prefer task A over task B, and the function or service capacity 388 may be limited to one task. The TX/RX device 364 may process tasks 1C and 2B since tasks C and B may be preferred over task A. Since task 1B may be processed in the remote TX/RX device 362 and with a function or service capacity 388 of up to two, two tasks may be processed.

The TX/RX device 366 may process tasks 3A and 2C since the TX/RX arbitration decision 386 prefers task A over task C, and with a function or service capacity 388 of up to two. Task 3A being the last A task to be processed and task 1C may be processed by remote TX/RX devices 364, leaving task 2C being the next priority task. With negotiated execution order 390b, a full capacity in processing seven tasks (1A to 3A, 1B, 2B and 1C, 2C) may be performed. In addition, a more evenly distributed task of B and C may be achieved. Alternately, the remote TX/RX devices 364 may be negotiated to perform tasks 2B and 3B and the remote TX/RX device 366 may perform tasks 3A and 1C. The new result may yield all A tasks, all B tasks and one C task (1A to 3A, 1B to 3B and 1C) being performed with no unused capacity. Additionally, the WMCD 350 may enjoy full user preference privilege ranking of being the first over the WMCDs 352 and 354.

In another embodiment of the invention, negotiation 356 and 358 among WMCDs 350, 352 and 354 may take place by rearranging user preference privilege ranking 380 to allow a more even task distribution among the WMCD users for fairness and satisfaction. For example parents (higher priority) may negotiate with children (lower priority) by granting certain privileges on TV channels or internet use as rewards for good behavior. This may be accomplished by re-programming the user preference data 350a to 354a, or by re-programming the TX/RX arbitration decision 386, or by re-programming negotiation functions 356 to 358, or 370 to 374. At the end of task execution or receiving services, an updated negotiated arbitration decision 392 may be stored in the WMCDs 350 to 354 and/or in the remote TX/RX devices 360 to 366 memory or in the remote host or storage 304.

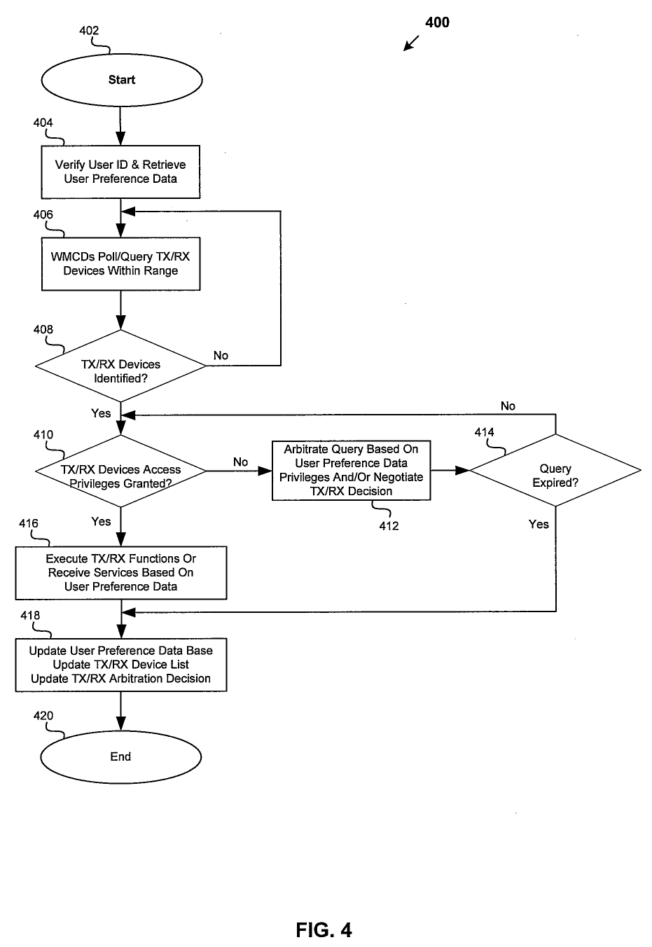

FIG. 4 is a flow diagram illustrating exemplary steps for a wireless mobile communication device (WMCD) to communicate a signal to execute functions and/or receive services in one or more remote transmitting/receiving (TX/RX) devices based on user preference data, in accordance with an exemplary embodiment of the invention. Following step 402 to power up the WMCD 302, step 404 may verify user ID and retrieve user preference data 302g locally in the WMCD 302 or remotely from the remote host or storage 304 through WLAN 310.

In step 406, the WMCD 302 may poll and query remote TX/RX devices 320 through 336 in the vicinity or within the communicating range through an ad hoc network 300A or 300B or through WLAN 310. In step 408, the queried remote TX/RX devices 320 through 336 may send a reply signal 320a to 336a in response to polling and query request to report identity and availability. If one or more remote TX/RX devices may not be identified, the WMCD 302 may return to step 406 to continue to poll and query. If one or more remote TX/RX devices 320 to 336 may be identified, step 410 may check whether the one or more remote TX/RX devices 320 through 336 may grant access privilege. The access privilege may be an indication of the availability of the remote TX/RX devices 320 through 366. The access privilege may be based on a user preference privilege ranking 380 among the WMCDs 350 through 354, a user preference task priority 382, an TX/RX device arbitration decision 386, a function or service capacity 388 of the remote TX/RX devices 360 to 366. In addition, negotiation 370 to 374 taking place among the remote TX/RX devices 360 through 366 may affect granting access privilege.

In instances where one or more remote TX/RX devices 360 through 366 may grant access privileges to the function or service request (task request) by the one or more WMCDs 350 through 354, in step 416 the remote TX/RX devices 360 through 366 may execute functions or services requested based on the user preference data 350a through 354a with respect to the user preference privilege ranking 380 and task priority 382 accordingly. Additionally, the functions or services execution order may be based on a TX/RX arbitration decision 386 pre-programmed in the remote TX/RX devices 360 through 366. In step 418, after execution of functions and services by the remote TX/RX devices 360 through 366, a user preference data base, an updated remote TX/RX device list and an update TX/RX arbitration decision may be updated and stored locally in the WMCD 350 through 354, locally in the remote TX/RX devices 360 through 366 and/or remotely in the remote host or storage 304 such as a server.

If one or more of the remote TX/RX devices 360 through 366 does not grant access privileges to the function or service request (task request) by the one or more WMCDs 350 through 354, in step 412 the remote TX/RX devices 360 through 366 may perform arbitration based on the user preference data 350a through 354a with respect to the user preference privilege ranking 380, task priority 382, the TX/RX arbitration decision 386, negotiation 370 through 374 among the remote TX/RX devices 360 to 366 and/or negotiation 356 and 358 among WMCDs 350 to 354.

After arbitration decision 386 and/or negotiation 370 through 374 and/or 356 to 358, a check for query expiration may take place in step 414. Step 414 may check how many times the same task, function or service may be queried for execution. A limit may be set to restrict the number of query by the same task, function or service. If the limit may not be reached, the task query may return to step 410 with the new negotiated arbitrated decision to check for access availability. If the limit has been exceeded, the task query may be aborted and not performed. The arbitration decisions, negotiation settings and along with updating the preference data, the availability of the remote TX/RX device 360 to 366 device list, WMCD 350 through 354 list may be updated into corresponding data bases in local memory 302b or remotely in remote host or storage 304 in step 418. Step 420 may terminate the function and service process.

In accordance with various embodiments of the invention, the method for communicating information in a wireless mobile communication device 302 may comprise an user interface 302d communicating a signal such as one of the signals 306, 308, 320a to 336a to one or more remote TX/RX devices 320 to 336 within operating range such as the ad hoc network 300a or WLAN 310 of the WMCD 302. One of the signals 306, 308, 320a to 336a indicates retrieved user preference data 302g that may be associated with a particular user 301 of the WMCD 302. The communicated signal such as one of the signals 306, 308, 320a to 336a may enable one or more remote TX/RX devices 320 to 336 to execute a function, or receive a service in accordance with the user preference data 302g.

At least a portion of the user preference data 302g may be from an input 302h acquired from a user 301 though data acquisition or downloading. The stored user preference data 302g may be retrieved locally in the WMCD 302 or from a source external to the WMCD 302 such as from a remote host or storage 304. The user preference data such as user preference data 302g, 350a through 354a may comprise one or more prioritized functions or services such as tasks 1A through 1C, 2A through 2C, 3A through 3C. One or more of the remote TX/RX devices 360 to 366 may be discovered by a WMCD 350 or by one or more WMCDs 350 through 354 through polling. One or more of the WMCDs 350 through 354 may be ranked through a user preference privilege ranking order 380.

One or more of the remote TX/RX devices 320 through 336 may each be capable of executing one or more available functions or provide one or more available services such as processing tasks 1A through 3C for WMCDs 350 through 354 in accordance to the user preference data 350a through 354a.

The WMCD 302 may generate signals such as one of signals 306, 308, 320a through 336a to enable TX/RX arbitration decision 386 of conflicts associated with execution of the available functions or receiving the available services by the one or more remote TX/RX devices 320 through 336. One such implementation may be through the user preference data 302g or 350a through 354a. The user preference data 302g or 350a through 354a may be used to set up negotiation operation 370 through 374 among the one or more remote TX/RX devices 320 through 336. In another embodiment of the invention, the TX/RX arbitration decision 386 and negotiation operation 370 through 374 may be set up independent of the user preference data instructions such as by pre-programming individually within each of the remote TX/RX devices 320 through 336. In another embodiment of the invention, the TX/RX arbitration decision 386 and negotiation operation 370 through 374 may be set up dynamically by a central control from a server such as from remote host or storage 304.

The user preference data 302g, 350a to 354a may be formatted in a universal language such as XML suitable for transmission through the internet. A portion of the user preference data 302g, 350a to 354a may be encrypted and function as a filter to filter unwanted information or communication traffic into the WMCD 302, 350 through 354.

Certain embodiments of the invention may comprise a machine-readable storage having stored thereon, a computer program having at least one code section for a wireless mobile communication device to execute a function or receive service in one or more remote transmit/receive devices based on user preference data, the at least one code section being executable by a machine for causing the machine to perform one or more of the steps described herein.

Accordingly, aspects of the invention may be realized in hardware, software, firmware or a combination thereof. The invention may be realized in a centralized fashion in at least one computer system or in a distributed fashion where different elements are spread across several interconnected computer systems. Any kind of computer system or other apparatus adapted for carrying out the methods described herein is suited. A typical combination of hardware, software and firmware may be a general-purpose computer system with a computer program that, when being loaded and executed, controls the computer system such that it carries out the methods described herein.

One embodiment of the present invention may be implemented as a board level product, as a single chip, application specific integrated circuit (ASIC), or with varying levels integrated on a single chip with other portions of the system as separate components. The degree of integration of the system will primarily be determined by speed and cost considerations. Because of the sophisticated nature of modern processors, it is possible to utilize a commercially available processor, which may be implemented external to an ASIC implementation of the present system. Alternatively, if the processor is available as an ASIC core or logic block, then the commercially available processor may be implemented as part of an ASIC device with various functions implemented as firmware.

The present invention may also be embedded in a computer program product, which comprises all the features enabling the implementation of the methods described herein, and which when loaded in a computer system is able to carry out these methods. Computer program in the present context may mean, for example, any expression, in any language, code or notation, of a set of instructions intended to cause a system having an information processing capability to perform a particular function either directly or after either or both of the following: a) conversion to another language, code or notation; b) reproduction in a different material form. However, other meanings of computer program within the understanding of those skilled in the art are also contemplated by the present invention.

While the invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

What is claimed is:

1. A method for communicating information, the method comprising:
in a wireless mobile communication device (WMCD) comprising an user interface, communicating a signal that indicates retrieved user preference data associated with a particular user of said WMCD, wherein said communicated signal enables one or more remote transmitting and/or receiving (TX/RX) devices, which receives said signal to execute a function or receive a service in accordance with said user preference data.

2. The method according to claim 1, comprising prioritizing one or more functions to be executed or services to be received in accordance with said user preference data.

3. The method according to claim 1, comprising discovering by said WMCD, of said one or more remote TX/RX devices.

4. The method according to claim 1, comprising ranking said WMCD.

5. The method according to claim 1, comprising retrieving at least a portion of said user preference data from within said WMCD and/or from a source external to said WMCD.

6. The method according to claim 1, comprising retrieving at least a portion of said user preference data from an input by said particular user of WMCD.

7. The method according to claim 1, comprising negotiating execution of one or more of said functions or receiving one or more of said services by said one or more remote TX/RX devices based on said user preference data.

8. The method according to claim 1, comprising negotiating execution based on arbitrating conflicts associated with one or more of said functions or receiving one or more of said services by said one or more remote TX/RX devices.

9. The method according to claim 1, comprising configuring said one or more remote TX/RX devices to execute said one or more available functions or receive said one or more available services based on said user preference data.

10. The method according to claim 1, comprising generating by said WMCD, one or more signals that enables arbitration of conflicts associated with execution of said available functions or receiving said available services by said one or more remote TX/RX devices.

11. The method according to claim 1, wherein said signal that indicates retrieved user preference data enables arbitration of conflicts associated with execution of said available functions or services by said one or more remote TX/RX devices.

12. The method according to claim 1, wherein said user preference data is represented in a universal language format.

13. The method according to claim 1, comprising encrypting at least a portion of said user preference data.

14. The method according to claim 1, comprising filtering information from said one or more remote TX/RX devices based on said user preference data.

15. The method according to claim 1, comprising polling information from said one or more remote TX/RX devices based on said user preference data.

16. A system for communicating information, the system comprising:
a WMCD comprising at least one processor and an user interface, said at least one processor enables communication of a signal that indicates retrieved user preference data associated with a particular user of said WMCD, wherein said communicated signal enables one or more remote transmitting and/or receiving (TX/RX) devices which receives said signal, to execute a function or receive a service in accordance with said user preference data.

17. The system according to claim 16, wherein said at least one processor enables prioritization of one or more functions to be executed or services to be received in accordance with said user preference data,

18. The system according to claim 16, wherein said at least one processor enables discovery, by said WMCD, of said one or more remote TX/RX devices.

19. The system according to claim 18, wherein said at least one processor enables ranking of said WMCD.

20. The system according to claim 16, wherein said at least one processor enables retrieval of at least a portion of said user preference data from within said WMCD and/or from a source external to said WMCD.

21. The system according to claim 16, wherein said at least one processor enables retrieval at least a portion of said user preference data from an input by said particular user of WMCD.

22. The system according to claim 16, wherein said at least one processor enables negotiation of execution of one or more of said functions or receiving one or more of said services by said one or more remote TX/RX devices based on said user preference data.

23. The system according to claim 16, wherein said at least one processor enables negotiation of execution of one or more of said functions or receiving one or more of said services based on arbitrating conflicts associated with said one or more of said functions or receiving said one or more of said services by said one or more remote TX/RX devices.

24. The system according to claim 16, wherein said at least one processor enables configuration of said one or more remote TX/RX devices to execute said one ore more available functions or receive said one or more available services based on said user preference data.

25. The system according to claim 16, wherein said at least one processor enables generation by said WMCD, one or more signals that enables arbitration of conflicts associated with execution of said available functions or receiving said available services by said one or more remote TX/RX devices.

26. The system according to claim 16, wherein said signal that indicates retrieved user preference data enables arbitration of conflicts associated with execution of said available functions or services by said one or more remote TX/RX devices.

27. The system according to claim 16, wherein said user preference data is represented in a universal language format.

28. The system according to claim 16, wherein said at least one processor enables encryption at least a portion of said user preference data.

29. The system according to claim 16, wherein said at least one processor enables filtering of information from said one or more remote TX/RX devices based on said user preference data.

30. The system according to claim 16, wherein said at least one processor enables polling of information from said one or more remote TX/RX devices based on said user preference data.
